(19) United States
(12) Patent Application Publication
(10) Pub. No.: US 2006/0133826 A1
(43) Pub. Date: Jun. 22, 2006

(54) Adaptive receiver for APD based modules

(75) Inventor: Jeff Hamilton-Gahart, Santa Rosa, CA (US)

Correspondence Address: Cindy S. Kaplan, P.O. BOX 2448, SARATOGA, CA, 95070, US

(73) Assignee: CISCO TECHNOLOGY, INC., SAN JOSE, CA (US)

(21) Appl. No.: 11/023,144

(22) Filed: Dec. 22, 2004

(51) Int. Cl. H04B 10/06

(52) U.S. Cl. 398/207

(57) ABSTRACT

An apparatus for protecting an optical receiver from high power optical signals is disclosed. The apparatus generally includes an optical receiver and a semiconductor optical device configured to receive optical signals and transmit the signals to the optical receiver and operable to decrease amplitude of an input signal received at the device above a predetermined power level range. The apparatus further includes a controller operable to increase attenuation of the semiconductor optical device such that the signal transmitted to the optical receiver from the semiconductor optical device is at an optimum power level for the optical receiver.

### BACKGROUND OF THE INVENTION

The present invention relates generally to optical communication network systems, and more specifically, to an adaptive receiver for protecting optoelectronic components, such as APD (avalanche photodiode) based modules, from high power optical signals.

Optical communication systems provide many advantages over conventional communication systems. Further improvements in optical communications hold great promise to meet the demand for greater bandwidth. Wavelength division multiplexing (WDM) is an optical technology that couples many wavelengths in the same fiber, thus effectively increasing the aggregate bandwidth per fiber to the sum of the bit rates of each wavelength and providing other advantages in implementation. Dense WDM (DWDM) is a technology with a larger (denser) number of wavelengths coupled into a fiber than WDM. DWDM combines multiple optical signals so that they can be amplified as a group and transported over a single fiber to increase capacity. The introduction of DWDM has enabled carriers to dramatically increase the data carrying capacity of existing fiber at a lower additional cost by separating light signals into tightly spaced wavelengths, each carrying a separate data signal.

Reconfigurable networks enhance a system by providing the ability to develop new wavelength-based services and more efficiently manage bandwidth. With reconfigurable optical networks, a signal is potentially routed through equipment from several different manufacturers. A signal may terminate at equipment at an unknown power level due to a lack of consistent signal conditioning, control, attenuation, amplification, or threshold levels across all equipment. As reconfigurable networks grow, there is an increased possibility of terminating at components, high power optical signals, which may be much higher than the maximum allowable threshold of the components at which the signal terminates. This problem will become more significant as reconfigurable networks go on-line and higher power DWDM signals are terminated in Metro Access gear.

Optical equipment that is susceptible to damage from these high power optical signals includes APD based receivers. APDs are similar to PIN (positive-intrinsic-negative photodiodes), but provide gain through an amplification process; one photon acting on the device releases many electrons. PIN photodiodes have many advantages, including low cost and reliability, but APDs have higher receive sensitivity and accuracy. Unlike a PIN diode, that only needs a bias of a few volts to function properly, an APD is biased with voltages up to 40 volts. When light strikes the device it leaks current in much the same way as a typical PIN diode, but at much higher levels.

APD based modules include transceivers, which are electro-optical subsystems that function to convert optical signals to electrical signals and vice versa. They operate as the interface between the optical fiber and the host PCB in data communication systems. Current transceivers include discrete, non-module based designs, 200-pin or 300-pin MSA (multi-source agreement) form-factors, which are fixed on the PCB (module design), and pluggable devices, including the XENPAK MSA form factor (10 Gbps transponder), X2 (10 Gbps transponder), SFPs (small form factor), and XFPs (10 Gbps form factor).

These components are often damaged from receiving power signals which are higher than their maximum damage threshold. These high power levels may come from the network during normal operation or may be the result of an incorrect power level setting. Currently, equipment suppliers are evaluating EDC (electronic dispersion compensation) for improved dispersion tolerance rather than power tolerance.

There is, therefore, a need for a receiver that can adapt power level to protect itself and downstream components and optimize the power input level for best BER (bit error rate) performance.

### SUMMARY OF THE INVENTION

An apparatus for protecting an optical receiver from high power optical signals is disclosed. The apparatus generally includes an optical receiver and a semiconductor optical device configured to receive optical signals and transmit the signals to the optical receiver and operable to decrease amplitude of an input signal received at the device above a predetermined power level range. The apparatus further includes a controller operable to increase attenuation of the semiconductor optical device such that the signal transmitted to the optical receiver from the semiconductor optical device is at an optimum power level for the optical receiver.

In one embodiment, the optical receiver is an avalanche photodiode based module and the semiconductor device is integrated into a receiver optical subassembly.

A method for protecting an optical receiver from high power optical signals generally comprises receiving at a semiconductor optical device an input signal, sensing a high power input signal received at the semiconductor optical device, decreasing the amplitude of the high power input signal, and increasing attenuation of the semiconductor optical device to provide an optimum power level at a receiver. The semiconductor optical device is configured to have small gain, high attenuation, and a large bandwidth and is coupled to the receiver.

Further understanding of the nature and advantages of the inventions herein may be realized by reference to the remaining portions of the specification and the attached drawings.

### BRIEF DESCRIPTION OF THE DRAWINGS

FIG. 1 is a block diagram of a system utilizing an adaptive receiver of the present invention.

FIG. 2 is a block diagram of the adaptive receiver.

FIG. 3 is a flowchart illustrating a process of the present invention for adapting power level to protect equipment and optimize input power level.

Corresponding reference characters indicate corresponding parts throughout the several views of the drawings.

### DETAILED DESCRIPTION OF THE INVENTION

The following description is presented to enable one of ordinary skill in the art to make and use the invention. Descriptions of specific embodiments and applications are provided only as examples and various modifications will be readily apparent to those skilled in the art. The general principles described herein may be applied to other embodiments and applications without departing from the scope of the invention. Thus, the present invention is not to be limited to the embodiments shown, but is to be accorded the widest scope consistent with the principles and features described herein. For purpose of clarity, details relating to technical material that is known in the technical fields related to the invention have not been described in detail.

An adaptive receiver for protecting optoelectronic components from damage due to high power optical signals is disclosed herein. The adaptive receiver is configured to adapt power level to protect components exposed to high power optical signals and optimize input power level for optimum BER (bit error rate (ratio of received bits to error bits)). The optoelectronic components may be, for example, APD (avalanche photodiode) based modules, such as discrete, non-module based designs, 200-pin or 300-pin MSA (multi-source agreement) form-factors, which are fixed on the PCB (module design), and pluggable devices, including the XENPAK MSA form factor (10 Gbps transponder), X2 (10 Gbps transponder), SFPs (small form factor), and XFPs (10 Gbps form factor), or any other component requiring protection from high power optical signals. The optoelectronic component may also be a PIN (positive-intrinsic-negative photodiodes) based device.

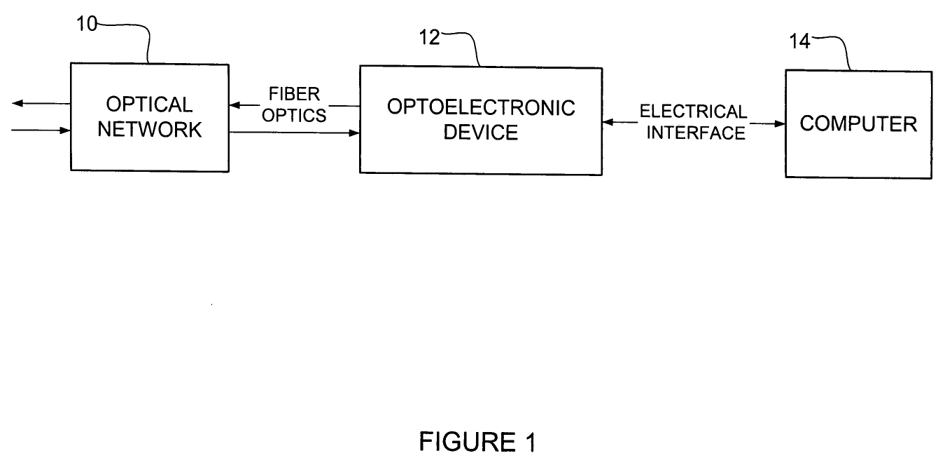

Referring now to the drawings, and first to FIG. 1, an example of a system utilizing an adaptive receiver of the present invention is shown. The system includes an optoelectronic device 12, which contains the adaptive receiver. The adaptive receiver is configured to receive fiber optics (e.g., 2.5 Gbps, 10 Gbps, 40 Gbps, or other data rates) and adapt power levels to protect the adaptive receiver and other components within the optoelectronic device 12.

The optoelectronic module 12 receives optical signals from a fiber optic cable coupled to an optical network 10, converts the optical signals to electrical signals, and provides the electrical signals to a host device (e.g., computer) 14. The module 12 also receives electrical signals from the computer 14 and converts the electrical signals to optical signals, and provides the optical signals to the fiber optic cable. The optoelectronic device 12 includes a transmitter optical subassembly (TOSA) and receiver optical subassembly (ROSA) (not shown). An optical connector optically couples the TOSA and ROSA to the optical network 10. The optoelectronic device 12 also includes an electrical connector which is electrically connected to a circuit board for transmitting electrical signals between the circuit board and host device 14.

The optoelectronic module 12 receives optical signals from the fiber optic cable using the (ROSA). The ROSA typically includes a lens that receives the optical signals from the fiber optic cable and focuses the optical signals on an optoelectronic device provided with a receiver unit. The adaptive receiver may be coupled to the ROSA or integrated directly into the ROSA of a currently available module form factor, for example. The integration may be monolithic or hybrid.

It is to be understood that the system shown in FIG. 1 and described herein is only one example, and that the adaptive receiver may be used in different systems (e.g., other bit rates and different modules), without departing from the scope of the invention.

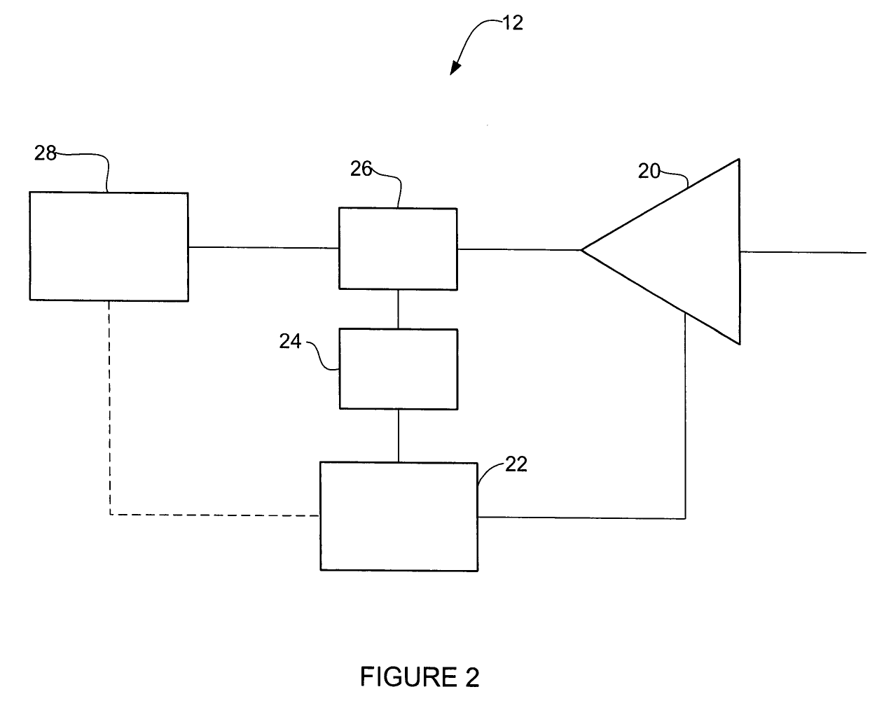

FIG. 2 illustrates one embodiment of the adaptive receiver. The adaptive receiver includes a semiconductor optical device referred to herein as a semiconductor optical attenuator/amplifier (SOAA) 20, an AGC (automatic gain controller) 22, photodetector (PD) 24, and tap 26. The photodetector 24 and tap 26 may be removed, without departing from the scope of the invention. The receiver is shown at 28. The receiver 28 may be configured with current clamp bias. The SOAA 20 is similar to a conventional semiconductor optical amplifier (SOA), but it is configured to provide a small amount of amplification and a large amount of attenuation. For example, in an ‘off’ state, the semiconductor optical attenuator/amplifier 20 can provide high attenuation. A conventional SOA is typically a high gain device which operates only over a small wavelength range. The SOAA 20 is a small gain device (e.g., 2 db) with a large bandwidth (e.g., 1250 nm-1650 nm). The semiconductor optical attenuator/amplifier 20 is configured to provide variable gain, which is controlled directly via bias current. Interference by the SOAA 20 is generally avoided by operating it in the linear regime.

The SOAA 20 includes multiple rare earth metals to provide the small gain over a large bandwidth (e.g., approximately 300 nm range). The SOAA preferably includes at least two different rare earth metals and may contain more that two different rare earth metals. For example, the SOAA 20 may be doped with erbium, strontium, or presodynium, or any combination of these and other rare earth metals, to provide the desired bandwidth, as is well known by those skilled in the art. The SOAA 20 is preferably an uncooled device, however a TEC (thermoelectric cooler) may be used.

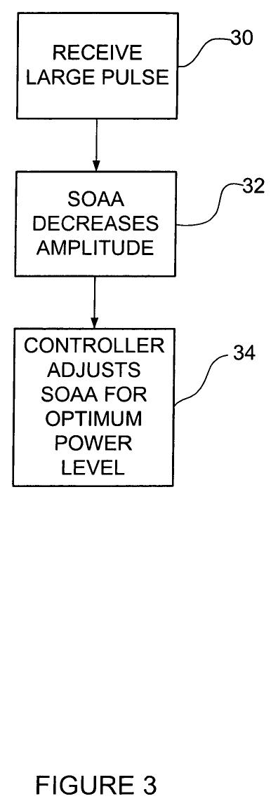

FIG. 3 is a flowchart illustrating a process for adapting incoming power level to protect equipment and optimize input power level for optimum BER. At step 30 a large pulse input is received. The SOAA 20 decreases input amplitude and widens the pulse (step 32). The SOAA 20 therefore protects the components from an initial high spike optical power signal before the controller 22 operates to adjust the SOAA to compensate for the high power signal. The AGC 22 then provides feedback to the SOAA 20 to increase attenuation by reverse biasing the SOAA (step 34). The AGC 22 thus operates to protect the receiver from high input power signals and allow the SOAA 20 to present the receiver with an optimum power level. The AGC 22 automatically adjusts the gain in a specified manner as a function of input level or another specified parameter. The input level may be adjusted to provide optimum BER. In one example, if the maximum power level of a single wavelength is +17 dBm, optimum power to present a 10 G APD is −10 dBm with 27 dB of attenuation. In most applications, the attenuation will not exceed approximately 30 dB.

Although the present invention has been described in accordance with the embodiments shown, one of ordinary skill in the art will readily recognize that there could be variations made to the embodiments without departing from the scope of the present invention. Accordingly, it is intended that all matter contained in the above description and shown in the accompanying drawings shall be interpreted as illustrative and not in a limiting sense.

What is claimed is:

1. An apparatus for protecting an optical receiver from high power optical signals, the apparatus comprising:
an optical receiver;
a semiconductor optical device configured to receive optical signals and transmit the signals to the optical receiver and operable to decrease amplitude of an input signal received at the device above a predetermined power level range; and
a controller operable to increase attenuation of the semiconductor optical device such that the signal transmitted to the optical receiver from the semiconductor optical device is at an optimum power level for the optical receiver.

2. The apparatus of claim 1 wherein the optical receiver is an avalanche photodiode based module.

3. The apparatus of claim 1 wherein the optimum power level is based on obtaining an optimum bit error rate.

4. The apparatus of claim 1 wherein the semiconductor optical device is a small gain device.

5. The apparatus of claim 4 wherein the semiconductor optical device has a gain of approximately 2 db and attenuation of approximately 30 dB over a 300 nm wavelength range.

6. The apparatus of claim 1 wherein the semiconductor optical device has a large bandwidth.

7. The apparatus of claim 6 wherein the bandwidth of the semiconductor device is approximately 1250 nm-1650 nm.

8. The apparatus of claim 1 wherein the semiconductor optical device is integrated into a receiver optical subassembly.

9. The apparatus of claim 1 wherein the semiconductor optical device comprises a plurality of different rare earth metals.

10. The apparatus of claim 9 wherein the rare earth metals are selected from the group consisting of erbium, strontium, and presodynium.

11. The apparatus of claim 1 further comprising a tap and a photodetector.

12. A method for protecting an optical receiver from high power optical signals, the method comprising:
receiving at a semiconductor optical device an input signal, the semiconductor optical device configured to have a small gain, high attenuation, and a large bandwidth and coupled to a receiver;
sensing a high power input signal received at the semiconductor optical device;
decreasing the amplitude of the high power input signal; and
increasing attenuation of the semiconductor optical device to provide an optimum power level at the receiver.

13. The method of claim 12 wherein the semiconductor optical device is configured to have a gain of approximately 2 dB, an attenuation of approximately 30 dB, and a bandwidth range of approximately 300 nm.

14. The method of claim 12 wherein the optimum power level is based on obtaining an optimum bit error rate.

15. The method of claim 12 wherein the semiconductor optical device 5 comprises at least two different rare earth metals.

16. The method of claim 15 wherein the rare earth metals are selected from the group consisting of erbium, strontium, and presodynium.

17. A system for protecting an optical receiver from high power optical signals, the system comprising:
means for receiving at a semiconductor optical device an input signal, the semiconductor optical device configured to have a small gain, high attenuation, and a large bandwidth and coupled to a receiver;
means for sensing a high power input signal received at the semiconductor optical device;
means for decreasing the amplitude of the high power input signal; and
means for increasing attenuation of the semiconductor optical device to provide an optimum power level at the receiver.

18. The system of claim 17 wherein the semiconductor optical device has a gain of approximately 2 db and attenuation of approximately 30 dB over a 300 nm wavelength range.

19. The system of claim 17 wherein the semiconductor optical device comprises at least two different rare earth metals.
